(19) United States
(12) Patent Application Publication
(10) Pub. No.: US 2015/0254714 A1
(43) Pub. Date: Sep. 10, 2015

(54) SYSTEMS AND METHODS FOR KEYWORD SUGGESTION

(71) Applicant: Yahoo! Inc., Sunnyvale, CA (US)

(72) Inventors: Laurence ZHUANG, Beijing (CN); Weiru Zhang, Beijing (CN); Xiao Han, Beijing (CN); Lin Ma, Beijing (CN); Tingyi Wu, Beijing (CN); Rohit Chandra, Sunnyvale, CA (US)

(73) Assignee: Yahoo! Inc., Sunnyvale, CA (US)

(21) Appl. No.: 14/242,252

(22) Filed: Apr. 1, 2014

Related U.S. Application Data
(63) Continuation of application No. PCT/CN2014/073133, filed on Mar. 10, 2014.

(51) Int. Cl. G06Q 30/02

(52) U.S. Cl. CPC G06Q 30/0256

(57) ABSTRACT

The present disclosure provides a system and method for suggesting a bidding keyword to an advertiser. The system includes a non-transitory processor-readable storage medium comprising a set of instructions for suggesting a bidding keyword to an advertiser; and a processor in communication with the storage medium. The processor is configured to execute the set of instruction to receive an advertisement creative from an advertiser; determine, based on the advertisement creative without using an externally input seed keyword, a recommended bidding keyword associated with the advertisement creative; and return the recommended keyword for online advertisement bidding.

### PRIORITY STATEMENT

This application is a continuation of International Application No. PCT/CN2014/073133, filed on Mar. 10, 2014, in the State Intellectual Property Office of the People's Republic of China, the disclosures of which is incorporated herein in its entirety by reference.

### BACKGROUND

This application relates generally to online advertising systems. More particularly, this application relates to systems and methods for keyword suggestion for online advertisers.

Online advertising has become increasingly popular as a way for advertisers to publicize information about goods and services to potential customers and clients. An advertiser can implement an advertising campaign using internet-accessible facilities of online providers such as Yahoo! Inc. The online provider serves to connect the advertiser with users accessing online resources such as search engines and news and information sites. Advertisements (“ads”) of the advertiser are provided to the users to inform and attract the attention of the users.

The online provider makes available a variety of marketplaces for advertisers to conduct an advertising campaign. For example, Yahoo! Inc. provides many of its popular web properties, such as its front page and home page, on personal computer (“PC”) and in applications (“apps”) on mobile platforms for advertising campaigns.

Some of the online ads are keyword dependent. For example, an advertiser may bid to display an ad on a search engine website based on search queries received from users. Native ads, a form of online advertising method in which the advertiser attempts to gain attention by providing content in the context of the user's experience, also heavily depend on keywords associated with a particular user.

Normally for these keyword dependent ads, when an advertiser unveiling a new product and/or service, the advertiser need to specify category information as well as a list of seed keywords (i.e., advertiser suggested bidding keywords) in addition to creating an advertisement creative associated with the product and/or service. The requirements for the initial category information and seed keywords place an additional burden on the advertiser, making an advertising service not as convenient. Further, because an advertiser may not be an expert in online advertising, the advertiser may not provide seed keywords that are accurate and effective. Thus, an online advertising system that provides automatic keyword and category suggestion may have more advantage in the advertising market.

### BRIEF SUMMARY

According to an aspect of the present disclosure, a system may comprise a non-transitory processor-readable storage medium comprising a set of instructions for suggesting a bidding keyword to an advertiser; and a processor in communication with the storage medium. The processor may be configured to execute the set of instruction to receive an advertisement creative from an advertiser; determine, based on the advertisement creative without using an externally input seed keyword, a recommended bidding keyword associated with the advertisement creative; and return the recommended keyword for online advertisement bidding.

According to another aspect of the present disclosure, a computer-implemented method for suggesting a bidding keyword to an advertiser may comprise receiving, by a computer, an advertisement creative from an advertiser; determining, by at least one computer based on the advertisement creative without using an externally input seed keyword, a recommended bidding keyword associated with the advertisement creative; and returning, by a computer, the recommended keyword for online advertisement bidding.

According to yet another aspect of the present disclosure, a non-transitory processor-readable storage medium may comprise a set of instructions configured to direct a processor to perform acts of: receiving an advertisement creative from an advertiser; determining, based on the advertisement creative without using an externally input seed keyword, a recommended bidding keyword associated with the advertisement creative; and returning the recommended keyword for online advertisement bidding.

These and other advantages, aspects, and novel features of the present disclosure, as well as details of illustrated embodiments thereof, will be more fully understood from the following description and drawings.

### BRIEF DESCRIPTION OF THE DRAWINGS

FIG. 1 is a block diagram of an example online information system;

FIG. 2 is a schematic diagram illustrating an example embodiment of a server;

FIG. 3 is a schematic diagram illustrating an example embodiment of a client device;

FIG. 4 is an example illustrating a system for providing an Internet searching page with a list of search results;

FIG. 5 is a schematic diagram of a bidding keyword suggesting system according to example embodiments of the present disclosure;

FIG. 6 is a flowchart illustrating how to determine a feature vector for a keyword;

FIG. 7 is a flowchart of a first phase of keyword suggestion according to the example embodiments of the present disclosure;

FIG. 8 is a flowchart illustrating a second phase of keyword suggestion according to the example embodiments of the present disclosure; and

FIG. 9 is a flowchart illustrating a regression training procedure according to the example embodiments of the present disclosure.

### DETAILED DESCRIPTION

Example embodiments in the present disclosure provide systems and methods for bidding keywords suggestion. The systems may implement the methods to help with providing an advertising service. Using the systems and methods, an advertiser is not required to provide initial seed keyword and/or category information of its advertisement creative in order to receive suggested keywords for bidding online advertisement auctions. To this end, the systems and methods may implement a two-phase keyword analysis method. In Phase 1 analysis the systems and methods may select a plurality of candidate keywords from a keywords database based on a feature similarity analysis. In Phase 1 analysis, the systems and methods may further refine the selection by comprehensively evaluating the feature similarity, a verbal similarity, and a category similarity of a candidate keyword with the advertisement creative. The final selection may be used by the advertiser as bidding keywords.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

An online information system places advertisements of advertisers within content services made available to end users, such as web pages, mobile applications (“apps”), TV apps, or other audio or visual content services. The advertisements are provided along with other contents. The other contents may include any combination of text, graphics, audio, video, or links to such content. The advertisements are conventionally selected based on a variety of criteria including those specified by the advertiser. The advertiser conventionally defines an advertising campaign to control how and when advertisements are made available to users and to specify the content of those advertisements. The content of the advertisements themselves is sometimes referred to as advertising creative or advertising creatives.

Various monetization techniques or models may be used in connection with sponsored advertising. In an auction type online advertising marketplace, advertisers may bid in connection with placement of advertisements, although other factors may also be included in determining advertisement selection or ranking. For keyword dependent advertisement, bids may be associated with one or more keywords or one or more search query associated with certain specified occurrences. Bids may also be associated with amounts advertisers pay for certain specified occurrences, such as for placed or clicked on advertisements, for example. Advertiser payment for online advertising may be divided between parties including one or more publishers or publisher networks, one or more marketplace facilitators or providers, or potentially among other parties.

Some models may include Guaranteed Delivery advertising, in which advertisers may pay based at least in part on an agreement guaranteeing or providing some measure of assurance that the advertiser will receive a certain agreed upon amount of suitable advertising, or nonguaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression (CPM) or number of impressions, cost per click or number of clicks (CPC), cost per action (CPA) for some specified action(s), cost per conversion or purchase, or cost based at least in part on some combination of metrics, which may include online or offline metrics.

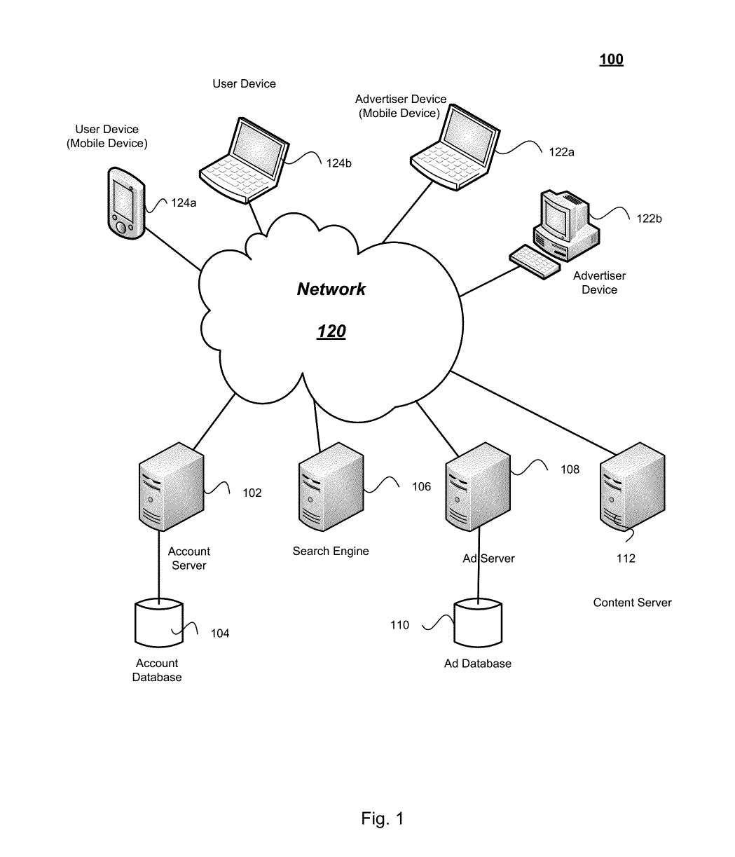

FIG. 1 is a block diagram of an online information system 100. The online information system 100 in the example embodiment of FIG. 1 may include an account server 102, and account database 104, a search engine 106, an advertisement (ad) server 108, and an ad database 110. The online information system 100 may be accessible over a network 120 by one or more advertiser devices, such as advertiser device 122a, 122b, and by one or more user devices, such as user device 124a, 124b. In various examples of such an online information system, users may search for and obtain content from sources over the network 120. Advertisers may provide advertisements for placement on web pages and other communications sent over the network to user devices such as the user device 124a, 124b. The online information system in one example may be deployed and operated by an online provider such as Yahoo! Inc.

The account server 102 may store account information for advertisers. The account server 102 may be in data communication with the account database 104. Account information may include one or more database records associated with each respective advertiser. Any suitable information may be stored, maintained, updated and read from the account database 104 by the account management server 102. Examples include advertiser identification information, advertiser security information such as passwords and other security credentials, and account balance information. In some embodiments, an online provider which manages the online information system 100 may assign one or more account managers to a respective advertiser, and information about the one or more account managers may be maintained in the account database 104 as well as information obtained and recorded for subsequent access by an account manager.

The account server 102 may be implemented using any suitable device. For example, the account management server 102 may be implemented as a single server, a plurality of servers, or any other type of computing device known in the art. Access to the account server 102 may be accomplished through a firewall, not shown, which protects the account management programs and the account information from external tampering. Additional security may be provided via enhancements to the standard communications protocols such as Secure HTTP or the Secure Sockets Layer.

The account server 102 may provide an advertiser front end to simplify the process of accessing the account information of an advertiser. The advertiser front end may be a program, application or software routine that forms a user interface. According to the example embodiments of the present disclosure, the advertiser front end may be accessible as a web site with one or more web pages that an accessing advertiser may view on an advertiser device such as advertiser device 122a, 122b. The advertiser may view and edit account data using the advertiser front end. After editing the advertising data, the account data may then be saved to the account database 104.

The search engine 106 may be a computer system, one or more servers, or any other computing device known in the art. Alternatively, the search engine 106 may be a computer program, instructions, or software code stored on a computer-readable storage medium that runs on a processor of a single server, a plurality of servers, or any other type of computing device known in the art. The search engine 106 may be accessed, for example, by user devices such as the user device 124a, 124b operated by a user over the network 120. The user device 124a, 124b may communicate a user query to the search engine 106. The search engine 106 may locate matching information using any suitable protocol or algorithm and returns information to the user device 124a, 124b. The search engine 106 may be designed to help users find information located on the Internet or an intranet. According to the example embodiments of the present disclosure, the search engine 106 may also provide to the user device 124a, 124b over the network 120 a web page with content including search results, information matching the context of a user inquiry, links to other network destinations or information and files of information of interest to a user operating the user device 124a, 124b.

The search engine 106 may enable a device, such as the user device 124a, 124b or any other client device, to search for files of interest using a search query. Typically, the search engine 106 may be accessed by a client device via one or more servers or directly over the network 120. The search engine 106 may, for example, comprise a crawler component, an indexer component, an index storage component, a search component, a ranking component, a cache, a profile storage component, a logon component, a profile builder, and one or more application program interfaces (APIs). The search engine 106 may be deployed in a distributed manner, such as via a set of distributed servers, for example. Components may be duplicated within a network, such as for redundancy or better access.

The ad server 108 may operate to serve advertisements to user devices such as the user device 124a, 124b. Advertisements include data defining advertisement information that may be of interest to a user of a user device. An advertisement may include text data, graphic data, image data, video data, or audio data. An advertisement may further include data defining one or more links to other network resources providing such data. The other locations may be other locations on the internet, other locations on an intranet operated by the advertiser, or any access.

For online information providers, advertisements may be displayed on web pages resulting from a user-defined search based at least in part upon one or more search terms. Advertisements may also be displayed based on content of a webpage that the user opens. Advertising may be beneficial to users, advertisers or web portals if displayed advertisements are relevant to interests of one or more users.

The ad server 108 may include logic and data operative to format the advertisement data for communication to the user device. The ad server 108 may be in data communication with the ad database 110. The ad database 110 may store information including data defining advertisements to be served to user devices. This advertisement data may be stored in the ad database 110 by another data processing device or by an advertiser.

Further, the ad server 108 may be in data communication with the network 120. The ad server 108 may communicate ad data and other information to devices over the network 120. This information may include advertisement data communicated to a user device. This information may also include advertisement data and other information communicated with an advertiser device such as the advertiser device 122a, 122b. An advertiser operating an advertiser device may access the ad server 108 over the network to access information including advertisement data. This access may include developing advertisement creative, editing advertisement data, deleting advertisement data and other activities.

The ad server 108 may provide an advertiser front end to simplify the process of accessing the advertising data of an advertiser. The advertiser front end may be a program, application or software routine that forms a user interface. In one particular embodiment, the advertiser front end is accessible as a web site with one or more web pages that an accessing advertiser may view on the advertiser device. The advertiser may view and edit advertising data using the advertiser front end. After editing the advertising data, the advertising data may then be saved to the ad database 110 for subsequent communication in advertisements to a user device.

The advertisement server 108 may be a computer system, one or more servers, or any other computing device known in the art. Alternatively, the advertisement server 108 may be a computer program, instructions and/or software code stored on a computer-readable storage medium that runs on a processor of a single server, a plurality of servers, or any other type of computing device known in the art.

The account server 102, the search engine 106, and the ad server 108, may be implemented as any suitable computing device. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

The network 120 may include any data communication network or combination of networks. A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network such as the network 120. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

The advertiser device 122a, 122b may include any data processing device which may access the online information system 100 over the network 120. The advertiser device 122a, 122b may be operative to interact over the network 120 with the account server 102, the search engine 106, the ad server 108, content servers and other data processing systems. The advertiser device 122a, 122b may, for example, implement a web browser for viewing web pages and submitting user requests. The advertiser device 122a, 122b may communicate data to the online information system 100, including data defining web pages and other information. The advertiser device 122a, 122b may receive communications from the online information system 100, including data defining web pages and advertising creatives.

The user device 124a, 124b may include any data processing device which may access the online information system 100 over the network 120. The user device 124a, 124b may be operative to interact over the network 120 with the search engine 106. The user device 124a, 124b may, for example, implement a web browser for viewing web pages and submitting user requests. A user operating the user device 124a, 124b may enter a search request and communicate the search request to the online information system 100. The search request may be processed by the search engine and search results may be returned to the user device 124a, 124b. In other examples, a user of the user device 124a, 124b may request data such as a page of information from the online information processing system 100. The data instead may be provided in another environment such as a native mobile application, TV application, or an audio application. The online information processing system 100 may provide the data or re-direct the browser to another web site. In addition, the ad server may select advertisements from the ad database 110 and include data defining the advertisements in the provided data to the user device 124a, 124b.

The advertiser device 122a, 122b and the user device 124a, 124b may operate as a client device when accessing information on the online information system. A client device such as the advertiser device 122a, 122b and the user device 124a, 124b may include a computing device capable of sending or receiving signals, such as via a wired or a wireless network. A client device may, for example, may include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. In the example of FIG. 1, a laptop computer 124b and a smartphone 124a may be operated interchangeably as an advertiser device or as a user device.

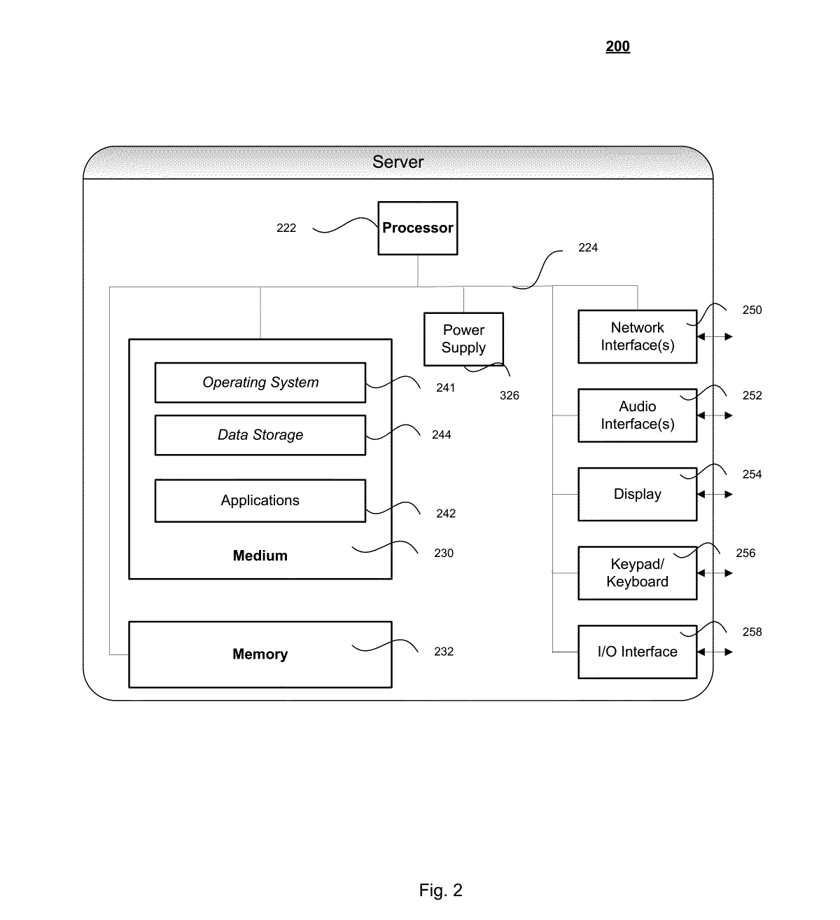

FIG. 2 is a schematic diagram illustrating an example embodiment of a server 200. The server 200 may be used as the account server 102, the search engine 106, and the ad server 108 of FIG. 1. A server 200 may vary widely in configuration or capabilities, but it may include one or more central processing units 222 and memory 232, one or more media 230 (such as one or more mass storage devices) storing application programs 242 or data 244, one or more power supplies 226, one or more wired or wireless network interfaces 250, one or more input/output interfaces 258, and/or one or more operating systems 241, such as Windows Server™, Mac OS X™, Unix™, Linux™, FreeBSD™, or the like. Thus a server 200 may include, as examples, dedicated rack-mounted servers, desktop computers, laptop computers, set top boxes, mobile computational devices such as smart phones, integrated devices combining various features, such as two or more features of the foregoing devices, or the like.

The account server 102, the search engine 106, content server 112 and the ad server 108 illustrated in FIG. 1 may be implemented as content servers or may be in communication with content servers. A content server may include a device that includes a configuration to provide content via a network to another device. A content server may, for example, host a site, such as a social networking site, examples of which may include, but are not limited to, Yahoo!™, Flicker™, Twitter™, Facebook™, LinkedIn™, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc. The content servers may not be under common ownership or control with the ad server or servers.

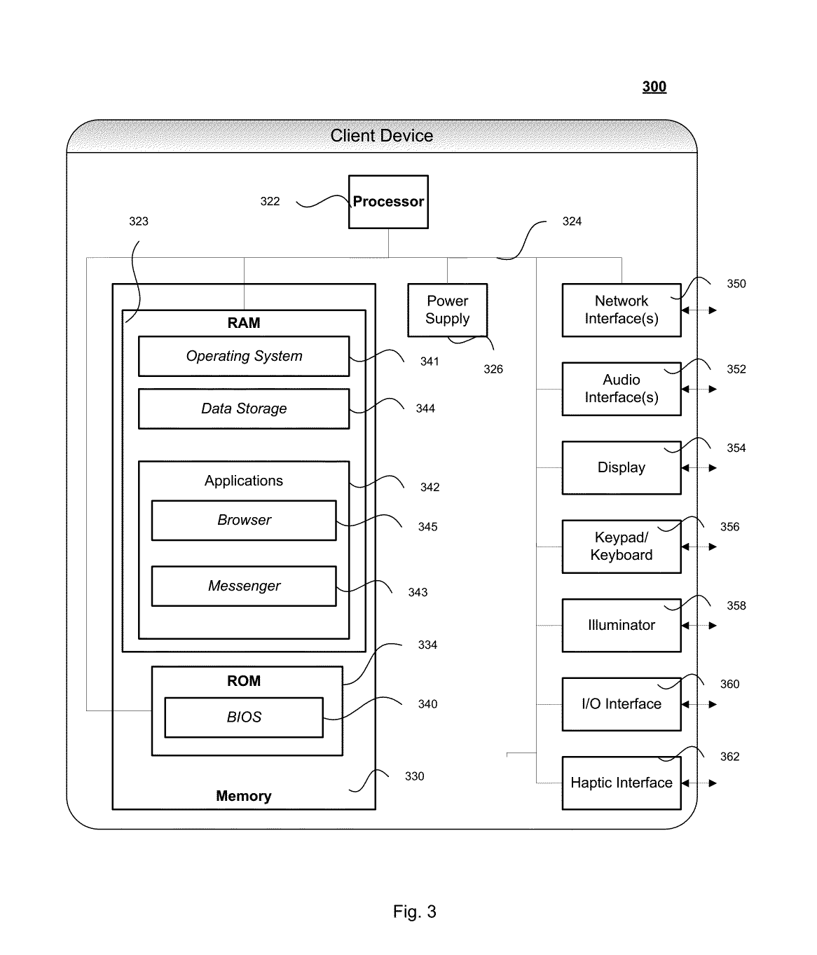

FIG. 3 is a schematic diagram illustrating an example embodiment of a client device that may be used as the user device 124a, 124b and the advertiser device 122a, 122b. The client device may include apparatuses to execute methods and software systems introduced in the present disclosure. A client device 300 may be a computing device capable of executing a software system. The client device 300 may, for example, be a device such as a personal desktop computer or a portable device, such as a laptop computer, a tablet computer, a cellular telephone, or a smart phone.

The client device 300 may vary in terms of capabilities or features. Claimed subject matter is intended to cover a wide range of potential variations. For example, the client device 300 may include a keypad/keyboard 356. It may also include a display 354, such as a liquid crystal display (LCD), or a display with a high degree of functionality, such as a touch-sensitive color 2D or 3D display. In contrast, however, as another example, a web-enabled client device 300 may include one or more physical or virtual keyboards, and mass storage medium 330.

The client device 300 may also include or may execute a variety of operating systems 341, including an operating system, such as a Windows™ or Linux™, or a mobile operating system, such as iOS™, Android™, or Windows Mobile™. The client device 300 may include or may execute a variety of possible applications 342, such as an electronic game 345. An application 342 may enable communication with other devices via a network, such as communicating with another computer, another client device, or server via a network.

Further, the client device 300 may include one or more non-transitory processor-readable storage media 330 and one or more processors 322 in communication with the non-transitory processor-readable storage media 530. For example, the non-transitory processor-readable storage media 330 may be a RAM memory, flash memory, ROM 334, 340 memory, EPROM memory, EEPROM memory, registers, hard disk, a removable disk, a CD-ROM, or any other form of non-transitory storage medium known in the art. The one or more non-transitory processor-readable storage media 330 may store sets of instructions, or units and/or modules that include the sets of instructions, for conducting operations and/or method steps described in the present disclosure. Alternatively, the units and/or modules may be hardware disposed in the client device 300 configured to conduct operations and/or method steps described in the present disclosure. The one or more processors may be configured to execute the sets of instructions and perform the operations in example embodiments of the present disclosure.

Merely for illustration, only one processor will be described in client devices and servers that execute operations and/or method steps in the following example embodiments. However, it should be note that the client devices and servers in the present disclosure may also include multiple processors, thus operations and/or method steps that are performed by one processor as described in the present disclosure may also be jointly or separately performed by the multiple processors. For example, if in the present disclosure a processor executes both step A and step B, it should be understood that step A and step B may also be performed by two different processors jointly or separately in the client device (e.g., the first processor executes step A and the second processor executes step B, or the first and second processors jointly execute steps A and B).

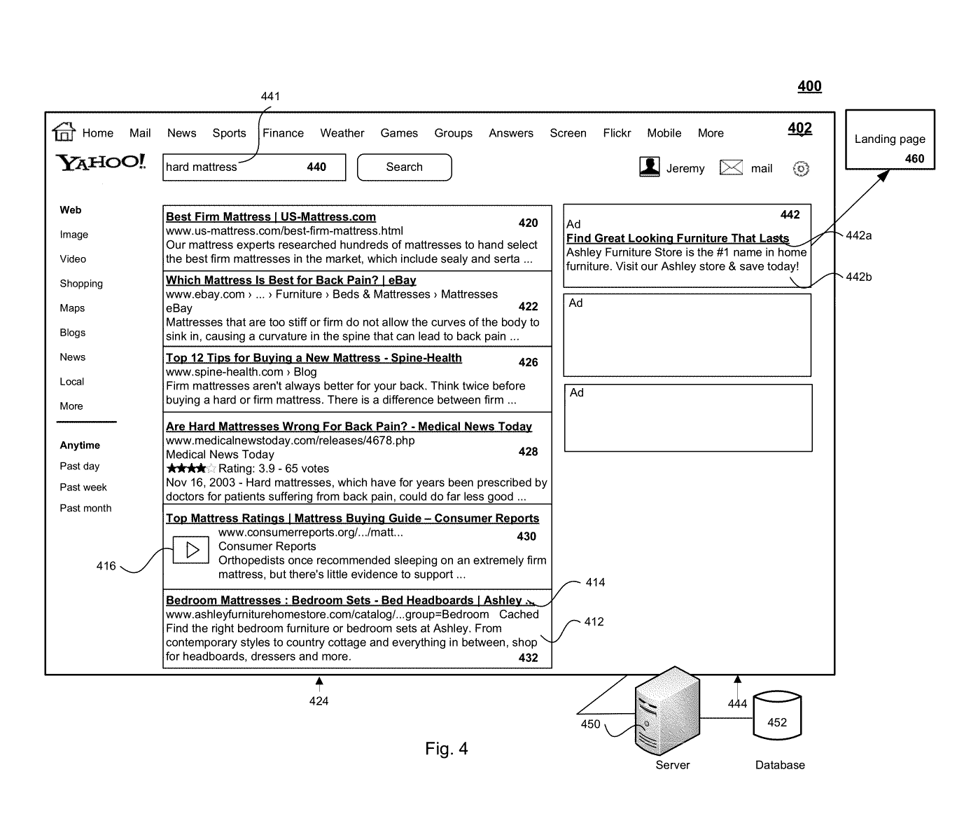

FIG. 4 is an example illustrating a system 400 for providing a web page with query search results. The system 400 may include at least one server 450. The server 450 may be a cumulative representation of the servers 102, 106, and 108 in FIG. 1 or may be a cumulative representation of a part of these servers. The server 450 may be in communication with at least one database 452 to provide data for a web page 400. The database 452 may include a content database, including a plurality of articles and/or web page links to be displayed on the web page 400. The articles may be any form of content items. For example, the articles may be textual items (e.g., textual reports, stories, etc.) or contents of multimedia (e.g., audio/video clips) or a combination thereof. The database 452 may also include an ad database, including a plurality of ads to be displayed in the website. The database 452 may be stored in a non-transitory processor-readable storage medium in communication with the server 450. The web page 402 shown in FIG. 4 is an example Internet searching page with searching result corresponding to a search query “hard mattress.” But the web page 402 may also be a front page, landing page, or a web page of a specific topic (e.g., sports, finance, news etc.) of a website. The web page 402 may be displayed on a browser of a user device 124a, 124b.

The web page 402 may include a search input box 440. A user may input a search query 441 in the search input box 440 and the server 450 may return and show search results on the web page 402. For example, in the web page 402 shown in FIG. 4, a user input a search query “hard mattress.”

The center column of the web page 402 may be a column of web page content 424. The web page content 424 may include a plurality of slots, in which a sequence of items 420, 422, 426, 428, 430, and 432 is displayed one item after another. Each item 422, 426, 428, 430, and 432 may be a search result corresponding to the search query “hard mattress.” Each item may include a textual summary 412 of the item. The item 422, 426, 428, 430, and 432 may also include graphics/videos 416, other data (not shown), and a link 414 to additional information of the item. Clicking or otherwise selecting the link 414 may re-direct the browser on the user device 124a, 124b to a web page with additional information.

The web page content 424 of items 422, 426, 428, 430, and 432 may include any type of content items. For example, the web page content 424 may include articles, including news, business-related articles, sports-related articles, etc. In addition to textual or graphical content, the articles 422, 426, 428, 430, and 432 may include other data, such as audio and video data or applications.

The position of the items 422, 426, 428, 430, and 432 in the web page content 424 may be determined based on relevance. For example, the first item 422 may be an article more relevant to the search query “hard mattress” than the sixth item 432. The position, however, may or may not be a precise indicator of popularity of the item to a user. For example, the sixth item 432, which is associated with a hard mattress provider, Ashley Furniture Industries Inc., may receive more clicks than the second item 422, which is an article related to back pain, although the second item 422 is more relevant to the search query “hard mattress” than the sixth item 432.

On the right hand side, the web page 402 may include a column 444 of advertisements, such as advertisement 442. The advertisement 442 may be designed to bring to the attention of the user and promote a product and/or service of an advertiser. For example, the advertisement 442 in FIG. 4 is designed to promote home furniture produced by Ashley Furniture Industries Inc. Additionally, the advertisement 442 may also be placed in the center column 424, or any other suitable places in the web page 402.

The creative of the advertisement 442 may include a name, e.g., the name of the advertiser; a title 442a, e.g., a title of the advertisement; and a description 442b, e.g., a description of a product and/or service of the advertiser. Only the title 442a and the description 442b of the creative may be displayed in the advertisement 442. Further, the title 442a may be displayed as a hyperlink, so that the user who clicks the title will be direct to a web page 460 (i.e., a landing page of the produce and/or service) of the advertiser. Table 1 shows an example of the creative of the advertisement 442.

TABLE 1

| | |
|---|---|
| Name | Ashley ™ Furniture Industries, Inc. |
| Title | Find Great Looking Furniture That Lasts |
| Description | Ashley Furniture Store is the #1 name in |
| | home furniture. Visit an Ashley store & |
| | save today! |

The advertisement 442 displays the title 442a as a hyperlink and the description 442b as pure text on the web page 402. When the user clicks the hyperlink, the user is directed to a homepage of Ashley Furniture Industries, Inc.

The advertiser may display the advertisement 442 through an online advertisement auction service provided by a publisher (e.g., the website 402 or an independent agent of the website 402). The advertiser may decide its bid based on similarities between the search query 441 and a list of bidding keyword associated with the advertisement 442. The list of bidding keyword may be provided by the publisher when the advertiser orders an ad displaying service from the publisher, so that the advertiser do not need to provide its own seed keyword and/or category information of the advertisement 442 to the publisher for keyword analyses.

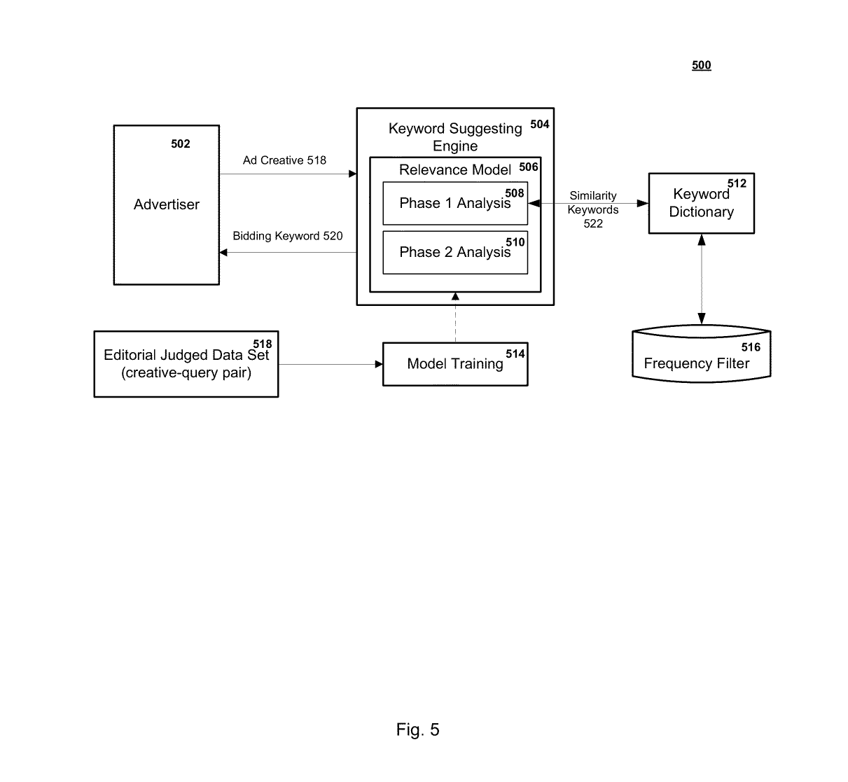

FIG. 5 is a schematic diagram of a system 500 for providing bidding keyword suggestion service to a server 502, according to example embodiments of the present disclosure. The system 500 may belong to an advertisement publisher, so that the keyword suggestion service is part of an online advertising service provided by the publisher. Alternatively, the system 500 may be an independent system from the publisher, providing an independent bidding keyword suggestion service to the advertiser.

The system 500 may include a keyword suggesting engine 504 configured to suggest bidding keywords to an advertiser without asking for an seed keyword associated with the creative as external input. The keyword suggesting engine 504 may be the server 200, including the processor 222 and the non-transitory storage medium 230. The storage media 230 may have a set of instructions stored therein. The set of instructions may direct the processor 222 to execute predetermined performances. For example, when an advertiser 502 inputs an advertisement creative (“creative”) 518 to the keyword suggesting engine 504, the processor 222 may execute a relevance model 506 (i.e., a set of instructions) stored in the medium 230 to conduct a two-phase keyword analysis, Phase 1 analysis 508 and Phase 2 analysis 510, to the creative 518 without using ad advertiser (or an agent of the advertiser) suggested seed keyword (i.e., a keyword to initiate a keyword analysis) associated with the creative. As a result, the keyword suggesting engine 504 may be able to return a list of suggested bidding keywords 520 to the advertiser without asking for an input of seed keyword or category information of the creative from the advertiser. In an example implementation, the keyword suggesting engine 504 may conduct a keyword analysis purely based on an input of the creative 518. The list of suggested bidding keywords may include a predetermined number (e.g., 50) of bidding keywords, ranked by relevance score (i.e., a recommendation degree) to the creative, so that the advertiser 502 may take the list of suggested bidding keywords 520 as keywords for bidding its advertisements in an online advertising auction to place its advertisement on the website of the publisher. Further, the analysis may be conducted based purely on an input of the creative 518 and may be accurate and effective enough so that there is no need for the advertiser 502 to provide its own set of bidding keyword for the auction or its own set of seed keywords for expanded keyword analysis.

In Phase 1 analysis 508, the processor 222 may select from a keyword database a predetermined number of candidate keywords based on an input. To this end, the keyword suggesting engine 504 may be in communication with a keyword dictionary 512, which is a pre-built database including millions of thousands of keywords, related keywords, rank scores (vectors) for the relevance between keywords, and a feature vector (or more feature vectors) corresponding to each keyword. The keywords may be provided by a frequency filter 516, which collects search queries input in Internet by general public during daily online activities over a certain period of time in the past of Yahoo! network. The frequency filter 516 may be configured to capture users' views and click behaviors on search result pages. The frequency filter 516 may function as a data source where top hundred million frequently searched keywords are picked out from the keyword dictionary 512. The keywords stored in the keyword dictionary 512 may be complete enough so that statistically it covers almost all keywords that an ordinary advertisement may need for bidding an advertisement auction.

In Phase 2 analysis 510, the processor 222 may further refine candidate keywords selected in Phase 1 analysis into the list of suggested bidding keywords. For example, the processor 222 may select 50 keywords from about 500 candidate keywords as the suggested bidding keywords using a linear regression algorithm. The linear regression algorithm may be pre-optimized through a training model 514 using a set of training data 518 manually judged by an editor.

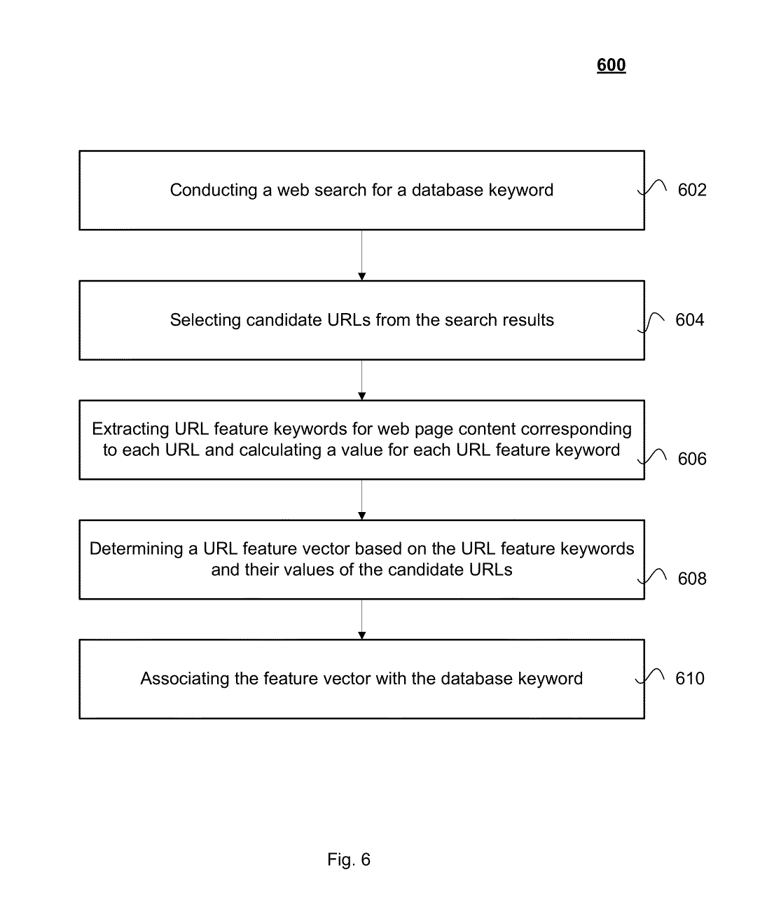

FIG. 6 is a flowchart illustrating how to determine a feature vector for a keyword in the pre-built keyword dictionary 512, according to example embodiments of the present disclosure. The procedure in the flowchart may be executed by a server, such as the server 200, having access to the keyword database saved in the keyword dictionary 512. The server may analysis the keyword database independently before the advertiser input the creative to the keyword suggesting engine 504.

In Step 602, the server may conduct an Internet search for each keyword (hereinafter “database keyword”) saved in the keyword database and obtain a list of search results. Each search result may correspond to a URL (uniform resource location). Further, the server may rank the list of URL by relativity of content in the URL with respect to the database keyword. The higher the rank of the URL, the more relative the content of the URL to the database keyword.

In Step 604, the server may select from the list of search results a predetermined number of candidate URLs that has the highest likelihood to be clicked by an ordinary user who searches the Internet with the database keyword. For example, the server may select only the top 10 URLs from the list of search results. Several factors may be considered when selecting the candidate URLs. For example, one factor, but not limited to, may be a position (i.e., the rank) of the URL in the list of URLs, i.e., the server may select those URLs that have content highly relevant to the database keyword. Another factor may be the number of times that the general public visited the URL over a period of time, i.e., the server may also select the most popular URLs (i.e., the URLs that were mostly clicked) in the list of URLs. Accordingly, the candidate URLs being selected may reflect both relevancy of the URL to the database keyword as well as the popularity of the URL among ordinary users surfed online, thereby reflecting likelihood that the URL will be selected by a user who searches the internet using the corresponding database keyword.

In Step 606, the server may extract a plurality of keywords (hereinafter “URL feature keywords”) from page content to which each URL points and calculate a value of importance for each URL feature keyword. To this end, the server may first extract the content of the URL. For example, the server may extract only the textual content from the URL, excluding any unrelated information such as advertisements. Then the server may compare the content with a dictionary (e.g., the keyword dictionary 512), which serves as an encyclopedia-type of keyword database, to extract the URL feature keywords from the content. Further, the server may calculate a value for each URL feature keyword that reflects the importance of the URL feature keyword in the content of the URL. The calculation may be based on a semantic value of the URL feature keyword as well as the likelihood that the corresponding URL will be selected by a user. For example, the server may conduct an TF-IDF (term frequency-inverse document frequency) analysis for each URL feature keyword throughout the page content to which a URL point, and obtain a corresponding TF-IDF score of the URL feature keyword. The server then may calculate the value of importance of the URL feature keyword using the formula:

$$value ( {f}_{i}^{d} ) = score ( {tfidf}_{i}^{d} ) \times [ 1 + log ( {click}^{d} + 1 ) ] \times [ 1 + \frac{α}{log ( {ave\_pos}^{d} + 1 )} ]$$

where d is document (web page content) to which URL point, fᵢ^{d} is the i^{th} URL feature keyword, α is an empirical value, [1+log(click^{d}+1)] is a weight corresponding to the number of clicks the URL received in history, and

$$[ 1 + \frac{α}{log ( {ave\_pos}^{d} + 1 )} ]$$

is a weight corresponding to the position (i.e., ranking or relevancy to the keyword) of the URL in the list of URL search result. Considering that a repeated search for a same keyword may not result the same URL search result, the position may be an average position of an URL among a predetermined number of searches.

The server may conduct the above URL feature keyword extractions and value of importance calculations for each candidate URL, and collect the URL feature keywords together. When a URL feature keyword appears in more than one candidate URL corresponded content, the server may add each individual value of importance of the URL feature keyword to obtain an overall value of importance of the URL feature keyword, following the formula:

$$score ( {f}_{i} ) = {\sum }_{d} score ( {f}_{i}^{d} )$$

In Step 608, the server may determine a feature vector (hereinafter “the database keyword feature vector”) for each of the database keyword in the keyword dictionary 512. To this end, the server may place all the words in the dictionary or all the keywords in the keyword database of the keyword dictionary 512 in a predetermined sequence, and treat the sequence as the feature vector template, so that each word in the sequence has a fixed position and becomes an element of the feature vector template. Accordingly, all the URL feature keywords of the candidate URLs may correspond to an element in the feature vector template. Next, the server may obtain the feature vector of a database keyword by assigning a value to each element in the feature vector template. If an element in the feature vector template is not a URL feature keyword, the server may assign a value of 0 to the element. If the element is a URL feature keyword, the server may assign the overall value of importance of the URL feature keyword to the element. Accordingly, the database keyword feature vector may be:

V_{(URL}_{_{—}}_{feature}_{_{—}}_{keyword)}{0,0, . . . ,0,score(k),0, . . . ,0,score(f₂),0, . . . ,0,score(fᵢ),0, . . . }

In step 610, the server may save the database keyword feature vector and associate it with the corresponding database keyword. The server may complete the above database keyword feature vector determination for each database keyword in the keyword dictionary 512 before the advertiser 505 input the creative 518.

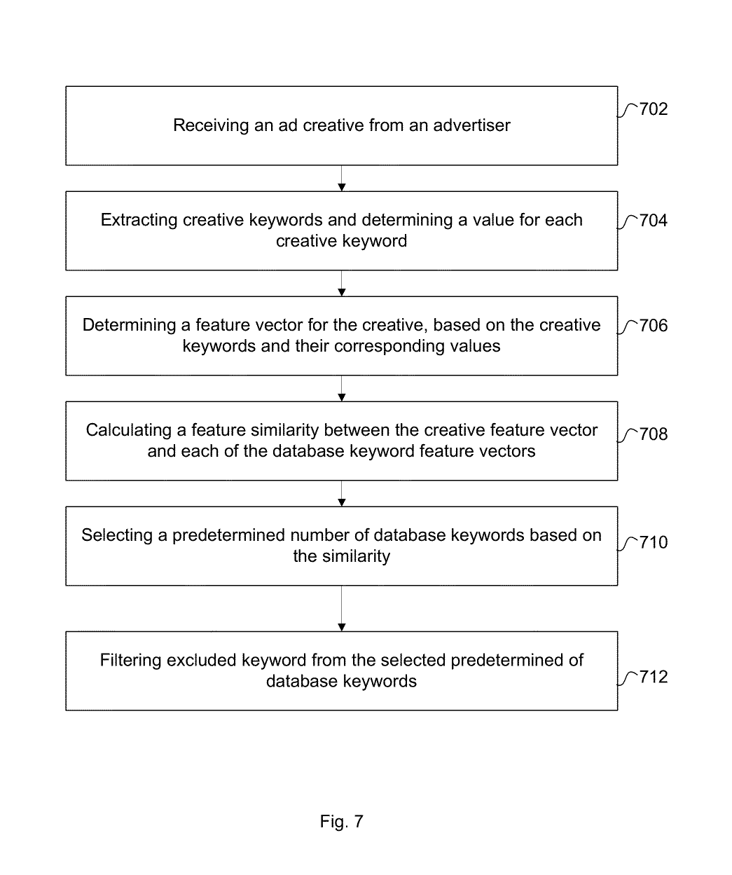

FIG. 7 is a flowchart of the Phase 1 analysis 508 according to example embodiments of the present disclosure. After receiving the creative 518 from the advertiser 502 in Step 702, the keyword suggesting engine 504 may determine a feature vector (hereinafter “the creative feature vector”) for the creative.

To this end, in Step 704, the keyword suggesting engine 504 may extract keywords (hereinafter “the creative keywords”) from the creative, based on the dictionary, in a similar way as the extraction procedure in Step 606. For example, for the creative in Table 1, the extracted creative keywords may be:
<Ashley, look, furniture, visit, today, home, furniture, industries, store, . . . >.

The keyword suggesting engine then may also calculate a value of importance for each of the creative keyword. For example, the keyword suggesting engine 504 may conduct an TF-IDF analysis to each of the creative keyword and obtain a value therefor. The TF-IDF value may be treated as the value of importance of the corresponding creative keyword. Accordingly, the value of importance for each creative keyword of the creative in Table 1 may be:
<Ashley: 0.465, look: 0.140, furniture: 0.447, visit: 0.151, today: 0.152, home: 10.13, furniture: 0.401, industries: 0.161, store: 0.234, . . . >.

In Step 706, the keyword suggesting engine 504 may determine the creative feature vector for the creative. To this end, the keyword suggesting engine 504 may use the feature vector template as described in Step 608, and assign a value of 0 to an element of the feature vector template if the element is not a creative keyword. If the element is a creative keyword, the keyword suggesting engine 504 may assign the value of importance corresponding to the creative keyword to the element. Accordingly, the creative feature vector of the creative in Table 1 may be

V_{(creative)}={0, . . . ,0.465, . . . ,0.140, . . . ,0.447, . . . ,0.151, . . . ,0.152, . . . ,10.13, . . . ,0.401, . . . ,0.161, . . . ,0.234, . . . }.

In Step 708, the keyword suggesting engine 504 may calculate a similarity value (e.g., cosine similarity) between the creative feature vector and each of the database keyword feature vector stored in the keyword dictionary 512. The higher the similarity between the creative feature vector and the database keyword feature vector, the more relevant the creative to the corresponding database keyword.

Then in Step 710, the keyword suggesting engine 504 may select a group of candidate keywords, including a predetermined number (e.g., 500) of database keywords that correspond to database keyword feature vectors having the highest similarities to the creative feature vector. These candidate keywords may represent the most relevant to the creative (e.g., the 500 most relevant keywords).

In some instance, not all candidate keywords may be ideal for or preferred by the advertiser to place bids. For example, the advertiser may determine not to place an advertisement in respond to a search query includes the name of a competitor of the advertiser. Accordingly, the keyword suggesting engine 504 may obtain an exclusion list for the advertiser. The exclusion list may be obtained from a database accessible by the keyword suggesting engine 504, or may be provided by the advertiser. The exclusion list may include competitor name of the advertiser, or may include other keywords that the advertiser does not wish to bid.

Next, in Step 712, the keyword suggesting engine 504 may refine the candidate keywords by filtering out keywords that are in the exclusion list from the candidate keywords. For example, the keyword suggesting engine 504 may analyze each candidate keyword and extract brand related terms from the candidate keyword. The keyword suggesting engine 504 may also analyze the creative and extract the brand related terms therein (e.g., Ashley from the creative in Table 1). If the candidate keyword does not include a brank related term, the candidate keyword may be content neutral. No further analysis may be needed. Otherwise, the keyword suggesting engine may compare the brand related terms from the creative and the brand related terms from a candidate keyword. If the terms have a large overlap, i.e., the two brand related terms are similar, the keyword suggesting engine 504 may determine the corresponding creative and candidate keyword are likely refer to the same brand of product or service. However, if the brand related term from the candidate keyword exists but has little or no overlap with the brand related term from the creative, the keyword suggesting engine 504 may determine that the brand related term is associated with a competitor. Accordingly, the corresponding candidate keyword may be removed from the candidate keyword group.

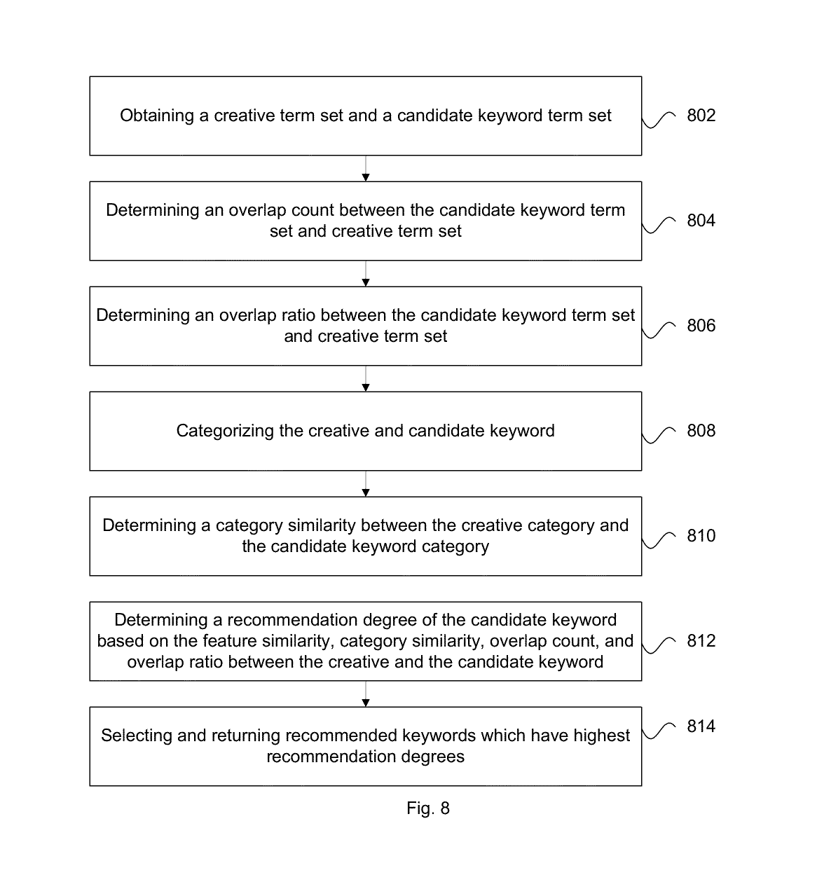

FIG. 8 is a flowchart illustrating Phase 2 analysis, according to the example embodiments of the present application. In Phase 2 analysis, the keyword suggesting engine 504 may evaluate the refined candidate keyword and further select a group of suggested keyword 520. The evaluation and selection may be based on a verbal similarity, a category similarity, as well as a feature similarity of a candidate keyword to the creative.

In Step 802, the keyword suggesting engine 504 may split the terms in the creative 518. Any word that is separated from other words in the creative by space and punctuation may be regarded as a single term. As result, the keyword suggesting engine 504 may obtain a creative term set. For example, for the creative in Table 1, the corresponding term set may be:
<ashley furniture industries inc. find great looking furniture that lasts ashley furniture store is the name in home furniture visit an ashley store save today>.
   Similarly, the keyword suggesting engine 504 may also obtain a term set for each of the refined candidate keywords. For example, for a keyword “home furniture suggestion,” the term set may be:
<home furniture suggestion>.

In Step 804, the keyword suggesting engine 504 may determine a verbal overlap count for each candidate keyword. The verbal overlap count may be the number of terms in the candidate keyword term set that also appear in the creative term set. In the example above, two terms “home” and “furniture” are overlap terms because they both appear in the keyword terms set and creative term set. Accordingly, the verbal overlap count of the keyword “home furniture suggestion is 2. The verbal overlap count may reflect an absolute degree of overlap between the candidate keyword and the creative. The larger the value of verbal overlap count, the more terms that the candidate keyword shares with the creative. Accordingly, the verbal overlap count may reflect an aspect of verbal similarity between a candidate keyword and the creative.

In Step 806, the keyword suggesting engine 506 may determine a verbal overlap ratio for each candidate keyword. The verbal overlap ratio may be a ratio between the verbal overlap count and the number of terms in the candidate keyword term set. For example, the term set <home furniture suggestion> includes 3 terms and has a verbal overlap count equals 2. Accordingly, its verbal overlap ratio is ⅔. The verbal overlap ratio may reflect a degree of perfectness the candidate keyword overlap with the creative. The larger the verbal overlap ratio, the better, or more “parallel,” the overlap is. Accordingly, the verbal overlap ratio may reflect another aspect of verbal similarity between a candidate keyword and the creative.

In Step 808, the keyword suggesting engine 504 may further categorize the creative and each keyword of the refined candidate keyword. For example, the keyword suggesting engine 504 may access a category analyzing setup, which is pre-built offline. The category analyzing setup may include a category database and may be configured to mapping each category with a set of pilot keywords. As a result, when the category analyzing setup receives a creative, it may search the map and determine one or more categories that best match keywords in the creative. For example, the creative in Table 1 may be categorized into 3 categories: retail, home, and appliance; the keyword “home furniture suggestion” may be categorized into 2 categories: retail and home.

In Step 810, the keyword suggesting engine 504 may further determine a category similarity between the creative and each keyword of the refined candidate keyword. The category similarity may be calculated under the formula of

Category_Similarity=category overlap count/creative category number.

In the above example, the category overlap count of the keyword is 2 because both there are 2 categories (i.e., “retail” and “home”) of the keyword “home furniture suggestion” overlap with the 3 categories (i.e., “retail,” “home,” and “appliances”) of the creative. Accordingly, the category similarity of the keyword is ⅔.

In Step 812, the keyword suggesting engine 504 may determine a recommendation degree to each of the refined candidate keyword. The determination may be based on the feature similarity, the verbal overlap count, the verbal overlap ratio, and the category similarity of a candidate keyword with respect to the creative. For example, the keyword suggesting engine 504 may take the feature similarity, the verbal overlap count, the verbal overlap ratio, and the category similarity of a candidate keyword with respect to the creative of a candidate keyword as input and execute a pre-trained linear regression algorithm. The linear regression algorithm may return a score (e.g., 0˜1) as the recommendation degree by evaluating the values of the input. The keyword suggesting engine 504 may take the candidate keyword only if the score is higher than or equals to a threshold value (e.g., 0.4).

Finally, in Step 814, the keyword suggesting engine 504 may select the candidate keyword with the highest recommendation degree as the suggested bidding keywords for the advertiser 502 and return the suggested bidding keywords.

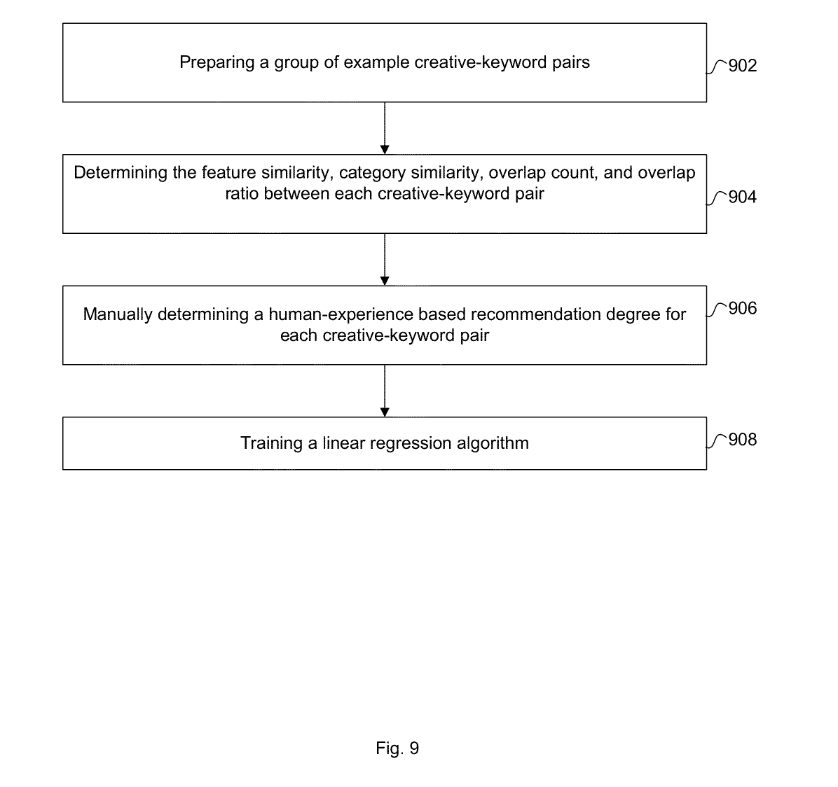

FIG. 9 is a flowchart illustrating a regression training procedure according to the example embodiments of the present disclosure. This procedure may be executed by a server such as server 200, and may be used to train the linear regression algorithm in Step 810.

In Step 902, an editor may prepare a group of example creative-keyword pairs. The editor may be a person, such as a designer of the keyword suggesting system 500. The group of example creative-keyword pairs may include about 100 creative, and each creative may pair with 30-50 keywords. Each keyword may be selected based on the creative.

In Step 904, the server may determine the feature similarity, category similarity, verbal overlap count, and verbal overlap ratio for the keyword in a same procedure as the Phase 1 and Phase 2 analyses.

In Step 906, a recommendation degree may be manually assigned to the creative-keyword pair based on actual human-experience to the creative-keyword pair. For example, an editor, who is a human being, may read each creative-keyword pair and label the creative-keyword pair with a score reflecting how strong he/she would recommend the keyword, i.e., how well the keyword matches the creative based on his/her feeling as a human being. The score may be a value between 0 and 1. For example, 1 may represent a perfect match, 0.7 may represent an excellent match, 0.5 may represent a good match, 0.4 may represent a fair match, and 0 may represent a bad match. Accordingly, each creative-keyword pair may have a manually labeled value.

In Step 908, the score as well as the feature similarity, category similarity, verbal overlap count, and verbal overlap ratio for the keyword may be used as training data to optimize the linear regression algorithm. As a result, the linear regression algorithm may be used to determine the score (i.e., recommendation degree) of a candidate keyword with the feature similarity, category similarity, verbal overlap count, and verbal overlap ratio for the candidate keyword as inputs.

The above example embodiments in the present disclosure provide systems and methods for bidding keywords suggestion. The system and methods may suggest bidding keywords to an advertiser based on creative that advertisers submitted. The advertisers are not required to provide initial seed keyword and/or category information to its advertisement creative in order to receive suggested keywords for bidding online advertisement opportunities. To this end, the system conducts a two-phase keyword suggestion analysis.

In Phase 1 analysis, the systems and methods may collect a database of keywords from search queries used by general public. Using selected search results of each keyword, the systems and methods may construct a database keyword feature vector for each keyword. When the systems and methods receive creative from an advertiser, the systems and methods may construct a creative feature vector and compare the creative feature vector with the database keyword feature vectors. The systems and methods then may pick up top keywords from the database, whose vectors have highest similarity (e.g., cosine similarity) to the creative feature vector. Finally, the systems and methods may remove the selected database keywords that contain excluded information, such as a competitor's name, and return the remaining selected database keywords as candidate keywords.

In Phase 2 analysis, the systems and methods may further refine the selection by evaluating each candidate keywords with the feature similarity, a category similarity and a verbal similarity between each candidate keyword and the creative. The finally selected candidate keywords may be returned as suggested keywords. The advertiser may use the suggested keywords in bidding online advertising opportunities.

While example embodiments of the present disclosure relate to systems and methods for online advertising keyword suggestion, the systems and methods may also be applied to other Applications. For example, in addition to suggest bidding keyword used in scenario when a user input a search query, the system and method may also be implemented to provide suggested web page content for online advertising. In another example, in addition to analysis advertisement creative, the methods and systems may also be implemented to analyze content of a web page.

Thus, example embodiments illustrated in FIGS. 1-9 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

We claim:

1. A computer system, comprising:
a non-transitory processor-readable storage medium comprising a set of instructions for suggesting a bidding keyword to an advertiser; and
a processor in communication with the storage medium configured to execute the set of instruction to:
receive an advertisement creative from an advertiser;
determine, based on the advertisement creative without using an externally input seed keyword, a recommended bidding keyword associated with the advertisement creative; and
return the recommended keyword for online advertisement bidding.

2. The system of claim 1, wherein to determine the recommended keyword the processor is further configured to execute the set of instruction to:
obtain a creative feature vector based on the advertisement creative;
obtain a plurality of keywords based on the advertisement creative without using a seed keyword provided by the advertiser, each of the plurality of keywords associated with a keyword feature vector;
determine a feature similarity between the creative feature vector and each of the plurality of keyword feature vector; and
select a plurality of candidate keywords from the plurality of keywords based on the similarities.

3. The system of claim 2, wherein to select the plurality of candidate keywords the processor is further configured to execute the set of instruction to:
remove a predetermined excluded keyword from the plurality of candidate keywords.

4. The system of claim 2, wherein to obtain a keyword feature vector the processor is further configured to execute the set of instruction to:
perform an Internet search to a keyword of the plurality of keywords to obtain a plurality of search results;
select a plurality of candidate search results from the plurality of search result based on a likelihood that a search result would be selected by a user who conducts an Internet search using the keyword;
determine an individual feature vector based on content of each of the plurality of candidate search results; and
form the keyword feature vector by combining the plurality of individual feature vectors.

5. The system of claim 4, wherein the likelihood that the search result would be selected by the user who conducts the Internet search using the keyword is determined based at least on a number that the search result was historically clicked and relevance the content of the search result to the keyword.

6. The system of claim 2, wherein the processor is further configured to execute the set of instruction to:
for each candidate keyword in the plurality of candidate keywords, determine a recommendation score based on at least the feature similarity, a verbal similarity, and a category similarity between the candidate keyword and the advertisement creative; and
selecting, by a computer, the recommended keyword from the plurality of candidate keywords based on the recommendation scores.

7. The system of claim 6, wherein the verbal similarity of the candidate keyword comprises:
a verbal overlap count, being a number of terms that appear both in the candidate keyword and in the advertisement creative; and
a verbal overlap ratio, being a ratio between the verbal overlap count and a total number of terms in the candidate keyword; and
wherein the category similarity of the candidate keyword comprises:
a category overlap count, being a number of categories that both the candidate keyword and the advertisement creative belong to; and
a category overlap ratio, being a ratio between the category overlap count and a total number of categories the candidate keyword belongs to.

8. A computer-implemented method for suggesting a bidding keyword to an advertiser, comprising:
receiving, by a computer, an advertisement creative from an advertiser;
determining, by at least one computer, based on the advertisement creative without using an externally input seed keyword, a recommended bidding keyword associated with the advertisement creative; and
returning, by a computer, the recommended keyword for online advertisement bidding.

9. The method of claim 8, wherein determining the recommended keyword comprises:
obtaining, by a computer, a creative feature vector based on the advertisement creative;
obtaining, by at least one computer, a plurality of keywords based on the advertisement creative without using a seed keyword provided by the advertiser, each of the plurality of keywords associated with a keyword feature vector;
determining, by a computer, a feature similarity between the creative feature vector and each of the plurality of keyword feature vector; and
selecting, by a computer, a plurality of candidate keywords from the plurality of keywords based on the similarities.

10. The method of claim 9, wherein selecting the plurality of candidate keywords further comprises:
removing, by a computer, a predetermined excluded keyword from the plurality of candidate keywords.

11. The method of claim 9, wherein obtaining a keyword feature vector comprises:
performing, by a computer, an Internet search to a keyword in the plurality of keywords to obtain a plurality of search results;
selecting, by a computer, a plurality of candidate search results from the plurality of search result based on a likelihood that a search result would be selected by a user who conducts an Internet search using the keyword;
determining, by a computer, an individual feature vector based on content of each of the plurality of candidate search results; and
forming, by a computer, the keyword feature vector by combining the plurality of individual feature vectors.

12. The method of claim 11, wherein the likelihood that the search result would be selected by the user who conducts the Internet search using the keyword is determined based at least on a number that the search result was historically clicked and relevance the content of the search result to the keyword.

13. The method of claim 9, further comprising:
for each candidate keyword in the plurality of candidate keywords, determining, by a computer, a recommendation score based on at least the feature similarity, a verbal similarity, and a category similarity between the candidate keyword and the advertisement creative; and
selecting, by a computer, the recommended keyword from the plurality of candidate keywords based on the recommendation scores.

14. The method of claim 13, wherein the verbal similarity of the candidate keyword comprises:
a verbal overlap count, being a number of terms that appear both in the candidate keyword and in the advertisement creative; and
a verbal overlap ratio, being a ratio between the keyword overlap count and a total number of terms in the candidate keyword; and
wherein the category similarity of the candidate keyword comprises:
a category overlap count, being a number of categories that both the candidate keyword and the advertisement creative belong to; and
a category overlap ratio, being a ratio between the category overlap count and a total number of categories the candidate keyword belongs to.

15. A non-transitory processor-readable storage medium, comprising a set of instructions configured to direct a processor to perform acts of:
receiving an advertisement creative from an advertiser;
determining, based on the advertisement creative without using an externally input seed keyword, a recommended bidding keyword associated with the advertisement creative; and
returning the recommended keyword for online advertisement bidding.

16. The storage medium of claim 15, wherein determining the recommended keyword comprises:
obtaining a creative feature vector based on the advertisement creative;
obtaining a plurality of keywords based on the advertisement creative without using a seed keyword provided by the advertiser, each of the plurality of keywords associated with a keyword feature vector;
determining a feature similarity between the creative feature vector and each of the plurality of keyword feature vector; and
selecting a plurality of candidate keywords from the plurality of keywords based on the similarities.

17. The storage medium of claim 16, further comprising removing a predetermined excluded keyword from the plurality of candidate keywords.

18. The storage medium of claim 16, wherein obtaining a keyword feature vector comprises:
performing an Internet search to a keyword in the plurality of keywords to obtain a plurality of search results;
selecting a plurality of candidate search results from the plurality of search result based on a likelihood that a search result would be selected by a user who conducts an Internet search using the keyword;
determining an individual feature vector based on content of each of the plurality of candidate search results; and
forming the keyword feature vector by combining the plurality of individual feature vectors,
wherein the likelihood that the search result would be selected by the user who conducts the Internet search using the keyword is determined based at least on a number that the search result was historically clicked and relevance the content of the search result to the keyword.

19. The storage medium of claim 16, further comprising:
for each candidate keyword in the plurality of candidate keywords, determining a recommendation score based on at least the feature similarity, a verbal similarity, and a category similarity between the candidate keyword and the advertisement creative; and
selecting the recommended keyword from the plurality of candidate keywords based on the recommendation scores.

20. The storage medium of claim 19, wherein the verbal similarity of the candidate keyword comprises:
a verbal overlap count, being a number of terms that appear both in the candidate keyword and in the advertisement creative; and
a verbal overlap ratio, being a ratio between the keyword overlap count and a total number of terms in the candidate keyword; and
wherein the category similarity of the candidate keyword comprises:
a category overlap count, being a number of categories that both the candidate keyword and the advertisement creative belong to; and
a category overlap ratio, being a ratio between the category overlap count and a total number of categories the candidate keyword belongs to.
